(19) United States
(12) Patent Application Publication
(10) Pub. No.: US 2026/0196363 A1
(43) Pub. Date: Jul. 9, 2026

(54) DIVERTOR

(71) Applicant: Kyoto Fusioneering Ltd., Tokyo (JP)

(72) Inventors: Satoshi KONISHI, Kyoto (JP); Yoshifumi KUME, Tokyo (JP); Yoshinao MATSUNAGA, Tokyo (JP)

(21) Appl. No.: 19/560,136

(22) Filed: Mar. 9, 2026

Related U.S. Application Data
(63) Continuation of application No. PCT/JP2024/032337, filed on Sep. 10, 2024.

(30) Foreign Application Priority Data
Sep. 13, 2023 (JP) 2023-148565

(51) Int. Cl. G21B 1/13

(52) U.S. Cl. CPC G21B 1/13

(57) ABSTRACT

A divertor 1 includes a casing 11, a jet body 12 which is installed inside the casing 11, an intake port 13 which is installed at an upper portion of the casing 11, an exhaust port 14 which is installed at a lower portion of the casing 11, a working fluid reservoir 15 which is installed at a bottom portion of the casing 11 and stores a working fluid, a jet nozzle 16 which ejects vapor of the working fluid, which is heated by a heater and thereby evaporated, in a downward direction, and a temperature adjustment pipe 17 which is installed to surround the casing 11. The working fluid is an alkali metal or a low-boiling-point metal.

NO. 2023-148565 filed in JP on September 13, 2023

NO. PCT/JP2024/032337 filed in WO on September 10, 2024.

### BACKGROUND

### 1. Technical Field

The present invention relates to a divertor for a nuclear fusion reactor.

### 2. Related Art

A divertor device (hereinafter, may be abbreviated as "divertor") to discharge charged particles and the like flowing out from plasma along magnetic field lines is installed in a nuclear fusion reactor (see, for example, Patent Document 1). Since a wall surface of the divertor is heated by radiant heat, high-energy neutral particles, and the like in addition to the charged particles, the wall surface receives an extremely high heat load.

### RELATED ART DOCUMENT

### PATENT DOCUMENT

Patent Document 1: Japanese Translation of PCT International Application Publication No. 2017-524928

### BRIEF DESCRIPTION OF THE DRAWINGS

FIG. 1 is a cross-sectional view of a divertor according to a first embodiment.

FIG. 2 is a cross-sectional view of a divertor according to a second embodiment.

### DESCRIPTION OF EXEMPLARY EMBODIMENTS

Hereinafter, the present invention will be described based on preferred embodiments with reference to the drawings. In the embodiments and modifications, same or equivalent components and members are denoted by same reference numerals, and redundant description is omitted as appropriate. In addition, dimensions of members in each drawing are appropriately enlarged and reduced in order to facilitate understanding. In addition, in each drawing, some of members that are not important for describing the embodiment are omitted from illustration. In addition, terms including ordinal numbers such as first and second are used to describe various components, but the terms are used only for purpose of distinguishing one component from other components, and the components are not limited by the terms. A nuclear fusion reactor generate power by converting a mixed fuel gas containing deuterium and tritium into plasma within a vacuum vessel for nuclear combustion, and extracting energy generated by a nuclear fusion reaction. Helium nuclei generated by the nuclear fusion reaction and nuclei, other than deuterium and tritium, which are mixed in from a vessel wall of the nuclear fusion reactor or the like radiate energy to lower a temperature of the plasma. Therefore, it is necessary to immediately discharge them. A divertor is a device for solving the above problem. The divertor causes charged particles of plasma hydrogen isotopes and impurity gases incident along magnetic field lines to collide with a wall surface called a target, and discharges the charged particles by a vacuum pump. This maintains purity of the plasma. The divertor is constituted by a space adjacent to nuclear fusion plasma in which a magnetic field by an electromagnet installed in its periphery exists, and a wall surface made of a material such as metal or ceramic surrounding the space. While the divertor exhausts and transfers plasma particles as gas to an outside of the plasma vessel by using a vacuum exhaust device, the divertor discharges energy held by the plasma particles through a cooling medium. The particles of the plasma transferred to the divertor are guided from the high-temperature plasma at hundreds of millions of degrees. Such particles hold energy externally supplied for heating, in addition to about 20% of the energy generated by the nuclear fusion reaction. These become thermal loads and are exerted on the divertor wall surface. It is known that, when receiving extremely high-density energy from the plasma, a target surface constituting the wall surface of the divertor is severely worn due to sputtering and thermal loads regardless of whether the energy is steady or transient. For the protection, for example, there is an idea of causing a liquid metal to flow on the surface, and the like, but a method of supplying and discharging the liquid metal has not yet been developed and has not been put to practical use. In addition, even if liquid is applied to the target surface, there is a problem that the liquid is evaporated by receiving the energy of the plasma particles and reaches an exhaust system and nuclear combustion plasma in a subsequent stage. There is no useful means to solve this. The present disclosure has been made in view of such problems, and an object thereof is to provide a divertor capable of discharging heat, plasma, and impurity gases while suppressing damage caused by the heat.

### First embodiment

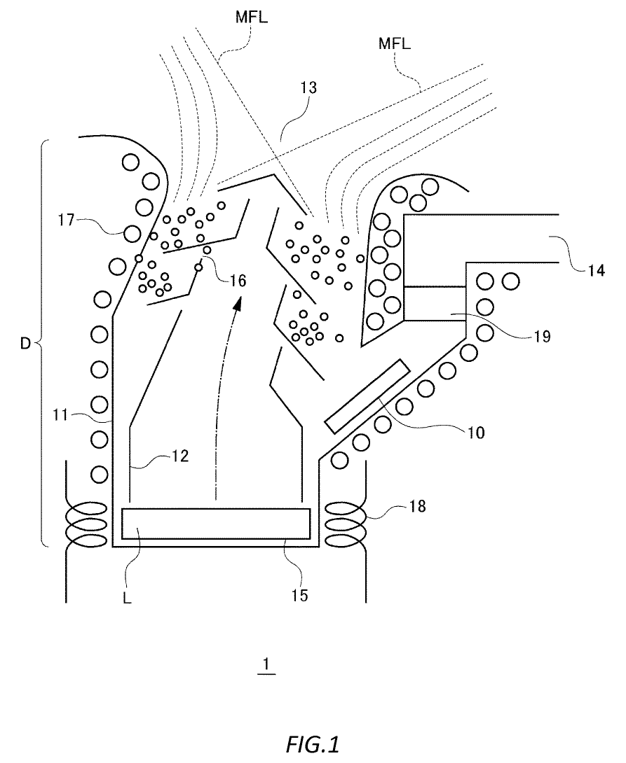

Hereinafter, a preferred embodiment of the present disclosure will be described with reference to FIG. 1. FIG. 1 is a cross-sectional view of a divertor 1 according to a first embodiment. The divertor 1 is formed as an exhaust device in a divertor region D of the nuclear fusion reactor (typically below the magnetic field lines of the vacuum vessel of the nuclear fusion reactor). The divertor 1 includes a target plate 10, a casing 11, a jet body 12 which is installed inside the casing 11, an intake port 13 which is installed at an upper portion of the casing 11, an exhaust port 14 which is installed at a lower portion of the casing 11, a working fluid reservoir 15 which is installed at a bottom portion of the casing 11, a side heater 18 which is installed outside the casing 11, a jet nozzle 16 which ejects vapor of a working fluid L, which is heated by the side heater 18 and thereby evaporated, in a downward direction, and a temperature adjustment pipe 17 which is installed to surround the casing 11. The working fluid L is a low-boiling-point liquid metal such as an alkali metal.

The casing 11 is typically cylindrical, but elements having any shape such as a rectangle, a trapezoid, or a sector shape having this cross section are combined and disposed in a plasma vacuum vessel. The casing 11 airtightly houses the jet body 12, the working fluid reservoir 15, and the like therein. The intake port 13 is provided at an upper portion (typically, an upper end) of the casing 11. The intake port is installed so as not to cross the magnetic field lines in a vicinity of an intersection of the magnetic field lines called separatrix. The exhaust port 14 is provided at a lower portion of the casing 11 (typically, a lower side surface of the casing 11). In particular, in order to prevent back-diffusion of the vapor of the working fluid L that may occur during non-steady-state operation such as upon startup or shutdown of the divertor 1, a baffle for preventing the vapor of the working liquid from flowing back into the intake port 13 may be selectively provided at the upper end of the casing 11.

The jet body 12 is also called a chimney, and is constituted by a plurality of concentric cylinders or flat plates having similar cross-sections. Three jet bodies 12 are illustrated in FIG. 1. The jet nozzles 16 which are tapered are formed at upper ends of the jet bodies 12. Each of these jet nozzles 16 is oriented downward in the casing 11. Each of the jet nozzles 16 is configured such that a gap between the jet nozzle 16 and an inner wall of the casing 11 gradually decreases toward a lower side of FIG. 1.

The working fluid reservoir 15 stores liquid as a working fluid. As will be described in detail later, this working fluid L is a liquid alkali metal or a low-boiling-point metal. The side heater 18 is installed outside the casing 11. The side heater 18 heats the working fluid L within the working fluid reservoir 15.

The temperature adjustment pipe 17 is installed to surround the casing 11. The temperature adjustment pipe 17 is, for example, a circular pipe that spirally surrounds the casing 11. Usually, the temperature adjustment pipe 17 operates as a cooling device in which a coolant circulates to cool an outer wall side surface of the casing 11 during operation of the divertor 1. However, as will be described later, since a boiling point of alkali metal or low-boiling-point metal as a working medium is high, it is necessary to configure the temperature adjustment pipe 17 to also operate as a heating device particularly upon startup of the divertor 1, and to control its temperature to be always higher than a normal temperature, thereby obtaining an appropriate temperature distribution.

The above is a configuration of the divertor 1. Next, operation of the divertor 1 will be described. The working fluid L stored at the bottom of the working fluid reservoir 15 is heated by the side heater 18 and thereby evaporated. The vapor of the working fluid L rises in a central portion of the jet body 12, and then is ejected from each jet nozzle 16 toward a lower side (that is, in an exhaust direction). Since an inside of the casing 11 is exhausted by a low-vacuum pump (not illustrated) installed on an exhaust side, the vapor of the working fluid L is accelerated to approximately a speed of sound (several hundred meters per second or more). Plasma particles guided by magnetic field lines MFL and flowing into the casing 11 through the intake port 13 is imparted with momentum in a flow direction of the vapor by colliding with the vapor accelerated to approximately the speed of sound. As a result, the plasma particles flow to the exhaust side and are discharged from the exhaust port 14. In this process, momentum is imparted by the vapor to a gas to be exhausted between each jet nozzle 16 and the inner wall of the casing 11, and a negative pressure is formed in the intake port 13 by a pump action, so that exhaust is performed extremely efficiently. In this way, the plasma particles are discharged from the divertor region.

On the other hand, the vapor of the working fluid L collides with the inner wall of the casing 11 and is cooled by heat exchange with the temperature adjustment pipe 17, whereby condensation occurs on the inner wall of the casing 11. The condensed working fluid L falls down or flows down on a wall surface, and is recovered as a liquid working fluid in the working fluid reservoir 15 and reused.

The divertor of the present embodiment uses an alkali metal or a low-boiling-point metal as the working fluid. This metal may be a suitable one such as a low-melting-point metal such as lithium, sodium, potassium, lead, tin, or indium, or an alloy thereof, but it is necessary to have a relatively low boiling point and a high vapor pressure upon heating. The divertor of the present embodiment has a structure similar to that of a diffusion pump using oils and fats or mercury vapor, but has technical features in a heating method and temperature distribution control, unlike oils and fats or mercury which are liquid at a normal temperature. In particular, there are various modifications in terms of not only performing heating and evaporation of metal as a working fluid at a high temperature but also appropriate temperature distribution setting and heating/cooling design necessary for condensation and liquefaction, circulation reuse, and the like for the metal, and the like. In particular, the casing 11 and the temperature adjustment pipe 17 are cooled by the diffusion pump for oils and fats and mercury, but in the present invention, it is basically necessary to perform control such that the temperature is always higher than the normal temperature, thereby preventing solidification of the liquid metal, forming appropriate temperature distribution, and maintaining an appropriate vapor pressure.

The plasma particles flowing into the divertor region have a high energy density, locally reaching tens to hundreds of MW/m². Therefore, if these particles collide directly with the solid wall constituting the divertor, it causes significant wear to the entire divertor. On the other hand, the energy flux is concentrated in an extremely narrow range of several millimeters. A vapor stream of alkali metal or low-boiling-point metal according to the present disclosure receives high-energy plasma particles in a divertor space. Further, also on a solid wall of the divertor, the working fluid of alkali metal or low-boiling-point metal can become liquid to receive the plasma particles. Accordingly, it is possible to prevent wear of the solid wall of the divertor. As described above, according to the present embodiment, it is possible to achieve a divertor capable of receiving plasma particles while suppressing damage caused by heat.

### Second embodiment

A divertor of a second embodiment includes the target plate 10 in the divertor region D. The target plate 10 may be composed of a carbon composite material, tungsten, and the like. According to the present embodiment, since the target plate 10 is provided, it is possible to prevent components within the divertor region D and the divertor vessel wall from being worn due to the plasma particles, and to suppress a risk such as leakage of the temperature adjustment pipe 17 to a minimum.

### Third embodiment

A divertor of a third embodiment includes a recovery mechanism for thermal energy held by the plasma particles flowing into the divertor region D. For thermal energy recovery, the temperature adjustment pipe 17 may be used, or a dedicated thermal energy recovery device may be provided outside.

As described above, the plasma particles flowing into the divertor region have a high energy density, locally reaching tens to hundreds of MW/m². This energy accounts for 20% to 30% of a total output of the nuclear fusion reactor. Recovery and reuse of these energies greatly contributes to improvement in energy balance of the nuclear fusion reactor, increase in amount of power generation through energy utilization, and improvement in energy conversion efficiency of an entire plant and reduction in power generation cost.

### Fourth embodiment

In a divertor of a fourth embodiment, the vapor of the working fluid L ejected from the jet nozzle 16 collides with the plasma particles, so that the energy held by the plasma particles is transferred to the vapor of the working fluid L. This prevents or suppresses the wear of the components within the divertor region D caused by the plasma particles.

As described above, the plasma particles flowing into the divertor region have a high energy density, locally reaching tens to hundreds of MW/m². Therefore, if these particles collide directly with the components within the divertor region D, it causes significant wear to the components. The energy flux is concentrated in an extremely narrow range of several millimeters. The vapor stream of alkali metal or low-boiling-point metal according to the present disclosure receives high-energy plasma particles in the divertor space. Further, also on a solid wall of the divertor, the working fluid of alkali metal or low-boiling-point metal can become liquid to receive the plasma particles. Accordingly, it is possible to prevent wear of the components within the divertor region D.

### Fifth embodiment

In a divertor of a fifth embodiment, the vapor of the working fluid L ejected from the jet nozzle 16 collides with the plasma particles, so that the energy held by the plasma particles is transferred to the vapor of the working fluid L. Accordingly, the plasma particles are discharged from the divertor region D.

The plasma particles flowing into the divertor region D contain helium generated by the nuclear fusion reaction and impurities released from the wall surface or the like in the reactor. Therefore, it is necessary to discharge them. The flow of the vapor of the working fluid L in the present embodiment imparts momentum in one direction to the plasma particles. Accordingly, the plasma particles are transferred to the exhaust port 14. That is, the divertor of the present embodiment has a function as a pump. This function does not have problems associated with a turbo molecular pump and a cryopump which are other exhaust devices, that is, problems such as difficulty of mechanical movement in the magnetic field and large tritium inventories. Therefore, according to the present embodiment, the plasma particles, which contain impurities, existing within the nuclear fusion reactor can be effectively and continuously discharged.

### Sixth embodiment

In a divertor of a sixth embodiment, the plasma particles are prevented from flowing back from the divertor region D into the plasma.

As described above, the divertor is a device for removing impurities from the nuclear fusion plasma and keeping the nuclear fusion plasma pure. Therefore, backflow into the nuclear fusion plasma, including the alkali metal or low-boiling-point metal that serves as the working fluid, is necessarily prevented. In particular, since the impurities in the nuclear fusion plasma radiate more heat as an atomic number is larger, it is necessary to keep the atomic number as low as possible. In the present embodiment, backflow of the alkali metal vapor such as lithium, which is working vapor, is not desirable, and the vapor of the molecular flow in one direction from the nozzle prevents this. Further, when lithium is used, the atomic number is 3, which is the second smallest after hydrogen and helium, and thus it is optimal for use in the divertor.

### Seventh embodiment

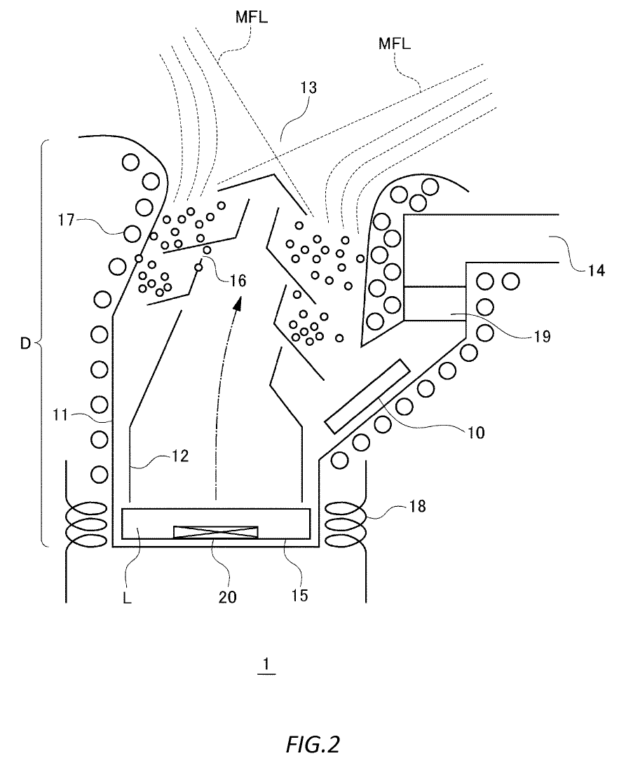

FIG. 2 is a cross-sectional view of the divertor 1 of a seventh embodiment. The divertor 1 of the seventh embodiment is different from the divertor 1 of the first embodiment in that a base heater 20 is installed at the bottom portion of the working fluid reservoir 15. The base heater 20 heats the working fluid L similarly to the side heater 18 installed on the outer wall of the casing 11 around the working fluid reservoir 15, that is, the outer wall of the lower portion of the casing 11. The side heater 18 and the base heater 20 are examples of the heater for heating the working fluid L, and the divertor 1 may include at least one of the side heater 18 or the base heater 20. The divertor 1 may include another heater installed at a position other than the side heater 18 and the base heater 20 as a heater for heating the working fluid L.

The working fluid L is preferably a liquid metal having a high vapor pressure and a low boiling point in order to operate the diffusion pump in a high-pressure environment. The working fluid L is, for example, preferably an alkali metal, an alkali metal alloy or another liquid metal having a relatively low boiling point and a high vapor pressure (for example, 100 Pa or more). The liquid metal having a low boiling point, that is, a low-boiling-point metal may be, for example, a metal having a boiling point at 1 atm (101.325 kPa) of less than 2950°C, preferably less than 2650°C, more preferably less than 1700°C, and still more preferably less than 1400°C. In addition, the low-boiling-point metal is preferably, for example, a metal having a boiling point at 1 atm of 400°C or higher. The alkali metal is preferably a metal having a boiling point at 1 atm of less than 1700°C, and more preferably less than 1400°C. The alkali metal that can be used as the working fluid L may be lithium (Li), sodium (Na), potassium (K), rubidium (Rb), cesium (Cs), francium (Fr), or an alloy thereof. The low-boiling-point metal other than the alkali metal that can be used as the working fluid L is preferably a metal other than mercury, and may be, for example, lead (Pb), indium (In), gallium (Ga), tin (Sn), or an alloy thereof.

The low-boiling-point metal may be, for example, a metal having a boiling point at a vapor pressure of 100 Pa of less than 1850°C, preferably less than 1500°C, more preferably less than 1100°C, and still more preferably less than 750°C. In addition, the low-boiling-point metal is preferably, for example, a metal having a boiling point at a vapor pressure of 100 Pa of 150°C or higher. The alkali metal is preferably a metal having a boiling point at a vapor pressure of 100 Pa of less than 1100°C, and more preferably less than 750°C.

The low-boiling-point metal may be, for example, a metal having a boiling point at a vapor pressure of 1 Torr (133.332 Pa) of less than 1850°C, preferably less than 1500°C, more preferably less than 1100°C, and still more preferably less than 750°C. The low-boiling-point metal is preferably, for example, a metal having a boiling point at a vapor pressure of 1 Torr (133.332 Pa) of 150°C or higher. The alkali metal is preferably a metal having a boiling point at 1 Torr (133.332 Pa) of less than 1100°C, and more preferably less than 750°C.

The temperature adjustment pipe 18 may have a function of being switchable between a cooling pipe and a heating pipe. The temperature adjustment pipe 18 may function as the cooling pipe by causing a cooling fluid to flow in the pipe. The temperature adjustment pipe 18 may function as the heating pipe by causing a heating fluid to flow in the pipe. Accordingly, the temperature adjustment pipe 18 can be operated as a cooling device that cools the inner wall side surface of the casing 11 to liquefy the vapor of the working fluid during operation, and can also be operated as a heating device upon startup. Here, the startup may be a period from when at least one of the base heater 20 or the side heater 18 starts heating the working fluid L to when the evaporation of the working fluid L stored in the working fluid reservoir 15 starts. The operation may be a period during which gas molecules within the vacuum vessel are introduced into the casing 11 via the intake port 13.

The temperature adjustment pipe 18 may function as the heating pipe to heat the inner wall side surface of the casing 11 during a period from when at least one of the base heater 20 or the side heater 18 starts heating the working fluid L to at least when the evaporation of the working fluid L starts, and then function as the cooling pipe to cool the inner wall side surface of the casing 11. The temperature adjustment pipe 18 may function as the heating pipe to heat the inner wall side surface of the casing 11 during the period from when at least one of the base heater 20 or the side heater 18 starts heating the working fluid L to at least when the evaporation of the working fluid L starts, and then, in response to the start of the evaporation of the working fluid L, function as the cooling pipe to cool the inner wall side surface of the casing 11. The temperature adjustment pipe 18 may function as the heating pipe to heat the inner wall side surface of the casing 11 during the period from when at least one of the base heater 20 or the side heater 18 starts heating the working fluid L to at least when the evaporation of the working fluid L starts, and then, in response to start of introduction of the gas molecules within the vacuum vessel into the casing 11 via the intake port 13, function as the cooling pipe to cool the inner wall side surface of the casing 11.

In the divertor 1 illustrated in FIG. 1, an example is illustrated in which the target plate 10 is provided on an inner wall side surface of a connection portion, near the exhaust port 14, between the exhaust port 14 and the casing 11. However, the target plate 10 may be provided at any place as long as it is the divertor region D. The target plate 10 may be provided on the entire inner wall side surface constituting the divertor region D of the casing 11.

In the above description, an example has been described in which the jet nozzle 16 ejects the vapor of the working fluid L, which is heated by at least one of the side heater 18 or the base heater 20 and thereby evaporated, in the downward direction, but the downward direction may be a direction including a component in a direction toward the bottom portion of the casing 11.

A part of the working fluid L leaks to the exhaust port 14. Therefore, the divertor 1 illustrated in FIGS. 1 and 2 may include a gas-liquid separator 19. By separating the liquid of the working fluid L from the exhaust gas using the gas-liquid separator 19, further stable operation of the device can be achieved.

The above has been described based on some embodiments of the present invention. It is to be understood by those skilled in the art that these embodiments are exemplary and that various modifications and changes can be made within the scope of the claims of the present invention, and that such modifications and changes are also within the scope of the claims of the present invention. Accordingly, the description and drawings herein should be treated as illustrative rather than restrictive.

The divertor of the present disclosure includes a diffusion pump type divertor mechanism instead of or in addition to a conventional divertor plate. Such a new type of divertor can be suitably applied to various types of nuclear fusion reactors such as a tokamak type, a helical type, and an RFP type.

Any combination of the embodiments and modifications described above is also useful as an embodiment of the present invention. A new embodiment generated by the combination has the effect of each of the combined embodiments and modifications.

In understanding the technical idea obtained by abstracting the embodiments and the modifications, the technical idea should not be interpreted limited to the contents of the embodiments and the modifications. The embodiment and modifications described above are only specific examples, and many design changes such as changes, additions, or deletions of components can be made. In the embodiments, contents where such design changes are possible are emphasized with the notation "embodiment". However, it goes without saying that design changes are allowed even for contents without such notation.

### Other possible items

### Item 1

A divertor for a nuclear fusion device, including:

a casing;

a jet body which is installed inside the casing;

an intake port which is installed at an upper portion of the casing;

an exhaust port which is installed at a lower portion of the casing;

a working fluid reservoir which is installed at a bottom portion of the casing and stores a working fluid;

a jet nozzle which ejects vapor of the working fluid, which is heated by a heater and thereby evaporated, in a direction including a component in a direction toward the bottom portion of the casing; and

a temperature adjustment pipe which is installed to surround the casing, wherein

the working fluid is an alkali metal or a low-boiling-point metal.

### Item 2

The divertor according to item 1, including, as the heater, at least one of a side heater installed outside the casing or a base heater installed at a bottom portion of the working fluid reservoir.

### Item 3

The divertor according to item 1, wherein the temperature adjustment pipe is switchable between a cooling pipe and a heating pipe.

### Item 4

The divertor according to item 3, wherein the temperature adjustment pipe functions as the heating pipe to heat an inner wall side surface of the casing during a period from when the heater starts heating the working fluid to at least when evaporation of the working fluid starts, and then functions as the cooling pipe to start cooling the inner wall side surface of the casing.

### Item 5

The divertor according to item 1, including a target plate in a divertor region.

### Item 6

The divertor according to any one of items 1 to 5, including a recovery mechanism for thermal energy held by plasma particles flowing into a divertor region.

### Item 7

The divertor according to any one of items 1 to 5, wherein as a result of collision between vapor of the working fluid ejected from the jet nozzle and plasma particles, energy held by the plasma particles is transferred to the vapor of the working fluid, and wear of components within a divertor region caused by the plasma particles is prevented or suppressed.

### Item 8

The divertor according to any one of items 1 to 5, wherein as a result of collision between vapor of the working fluid ejected from the jet nozzle and plasma particles, energy held by the plasma particles is transferred to the vapor of the working fluid, and the plasma particles are discharged from a divertor region.

### Item 9

The divertor according to item 8, wherein the plasma particles are prevented from flowing back into the divertor region.

### EXPLANATION OF REFERENCES

1: divertor;

10: target plate;

11: casing;

12: jet body;

13: intake port;

14: exhaust port;

15: working fluid reservoir;

16: jet nozzle;

17: temperature adjustment pipe;

18: side heater;

19: gas-liquid separator;

20: base heater;

MFL: magnetic field line;

L: working fluid; and

D: divertor region.

What is claimed is:

1. A divertor for a nuclear fusion device, comprising:
a casing;
a jet body which is installed inside the casing;
an intake port which is installed at an upper portion of the casing;
an exhaust port which is installed at a lower portion of the casing;
a working fluid reservoir which is installed at a bottom portion of the casing and stores a working fluid;
a jet nozzle which ejects vapor of the working fluid, which is heated by a heater and thereby evaporated, in a direction including a component in a direction toward the bottom portion of the casing; and
a temperature adjustment pipe which is installed to surround the casing, wherein
the working fluid is an alkali metal or a low-boiling-point metal.

2. The divertor according to claim 1, comprising, as the heater, at least one of a side heater installed outside the casing or a base heater installed at a bottom portion of the working fluid reservoir.

3. The divertor according to claim 1, wherein the temperature adjustment pipe is switchable between a cooling pipe and a heating pipe.

4. The divertor according to claim 3, wherein the temperature adjustment pipe functions as the heating pipe to heat an inner wall side surface of the casing during a period from when the heater starts heating the working fluid to at least when evaporation of the working fluid starts, and then functions as the cooling pipe to start cooling the inner wall side surface of the casing.

5. The divertor according to claim 2, wherein the temperature adjustment pipe is switchable between a cooling pipe and a heating pipe.

6. The divertor according to claim 5, wherein the temperature adjustment pipe functions as the heating pipe to heat an inner wall side surface of the casing during a period from when the heater starts heating the working fluid to at least when evaporation of the working fluid starts, and then functions as the cooling pipe to start cooling the inner wall side surface of the casing.

7. The divertor according to claim 1, comprising a target plate in a divertor region.

8. The divertor according to claim 1, comprising a recovery mechanism for thermal energy held by plasma particles flowing into a divertor region.

9. The divertor according to claim 2, comprising a recovery mechanism for thermal energy held by plasma particles flowing into a divertor region.

10. The divertor according to claim 3, comprising a recovery mechanism for thermal energy held by plasma particles flowing into a divertor region.

11. The divertor according to claim 5, comprising a recovery mechanism for thermal energy held by plasma particles flowing into a divertor region.

12. The divertor according to claim 1, wherein as a result of collision between vapor of the working fluid ejected from the jet nozzle and plasma particles, energy held by the plasma particles is transferred to the vapor of the working fluid, and wear of components within a divertor region caused by the plasma particles is prevented or suppressed.

13. The divertor according to claim 2, wherein as a result of collision between vapor of the working fluid ejected from the jet nozzle and plasma particles, energy held by the plasma particles is transferred to the vapor of the working fluid, and wear of components within a divertor region caused by the plasma particles is prevented or suppressed.

14. The divertor according to claim 3, wherein as a result of collision between vapor of the working fluid ejected from the jet nozzle and plasma particles, energy held by the plasma particles is transferred to the vapor of the working fluid, and wear of components within a divertor region caused by the plasma particles is prevented or suppressed.

15. The divertor according to claim 5, wherein as a result of collision between vapor of the working fluid ejected from the jet nozzle and plasma particles, energy held by the plasma particles is transferred to the vapor of the working fluid, and wear of components within a divertor region caused by the plasma particles is prevented or suppressed.

16. The divertor according to claim 1, wherein as a result of collision between vapor of the working fluid ejected from the jet nozzle and plasma particles, energy held by the plasma particles is transferred to the vapor of the working fluid, and the plasma particles are discharged from a divertor region.

17. The divertor according to claim 2, wherein as a result of collision between vapor of the working fluid ejected from the jet nozzle and plasma particles, energy held by the plasma particles is transferred to the vapor of the working fluid, and the plasma particles are discharged from a divertor region.

18. The divertor according to claim 3, wherein as a result of collision between vapor of the working fluid ejected from the jet nozzle and plasma particles, energy held by the plasma particles is transferred to the vapor of the working fluid, and the plasma particles are discharged from a divertor region.

19. The divertor according to claim 5, wherein as a result of collision between vapor of the working fluid ejected from the jet nozzle and plasma particles, energy held by the plasma particles is transferred to the vapor of the working fluid, and the plasma particles are discharged from a divertor region.

20. The divertor according to claim 16, wherein the plasma particles are prevented from flowing back into the divertor region.
